(19) United States
(12) Patent Application Publication
(10) Pub. No.: US 2023/0418453 A1
(43) Pub. Date: Dec. 28, 2023

(54) CLIENT DEVICE WITH SLIDERS FOR SELECTING SEARCHED DIGITAL MEDIA CONTENT

(71) Applicant: Preamble, Inc., Pittsburgh, PA (US)

(72) Inventors: Jonathan Cefalu, La Habra, CA (US); Jeremy Charles McHugh, Pittsburg, PA (US); Dylan Hadfield-Menell, Cambridge, MA (US)

(21) Appl. No.: 18/214,724

(22) Filed: Jun. 27, 2023

Related U.S. Application Data
(60) Provisional application No. 63/355,772, filed on Jun. 27, 2022.

(51) Int. Cl. G06F 3/04847; G06F 16/435; G06F 16/438

(52) U.S. Cl. CPC G06F 3/04847; G06F 16/435; G06F 16/438

(57) ABSTRACT

A client device having a user interface, and a display displaying a graphical slider on the display that is associated with a theme of digital media content. A processor is responsive to a user moving the displayed slider between a first position and a second position, wherein the first position is correlated to a first type of digital media content and the second position is correlated to a second type of digital media content. The processor uses the position of the slider as search criteria and searches uniform resource locator (URL) content of a server that is associated with the theme of digital media content. The processor returns selected digital media content that correlates to the type of media content as a function of the slider position.

### CLAIM OF PRIORITY

This application claims priority of U.S. Provisional Patent No. 63/355,772 filed Jun. 27, 2022 entitled Trained Machine Learned Mode for Ranking Content, the teachings of which are incorporated herein by reference in their entirety.

### TECHNICAL FIELD

Neural networks represent deep learning using artificial intelligence. Certain application scenarios are too heavy or out of scope for traditional machine learned (ML) algorithms to handle. Neural networks assist in such scenarios and fill the gap.

### BRIEF DESCRIPTION OF THE FIGURES

The drawing figures depict one or more implementations, by way of example only, not by way of limitations. In the figures, like reference numerals refer to the same or similar elements.

FIG. 1 is a flow chart of a method of training a ML model according to this disclosure;

FIG. 2 illustrates a 2-level space of extracted features, with a 2-dimensional (2D) line separating different concepts;

FIG. 3 is a diagram illustrating new content, such as URLs, ranked-up or ranked-down based on the concepts in high-level feature embedding;

FIG. 4A illustrates content that is pinned;

FIG. 4B illustrates content that is ranked significantly up to non-pinned position #1;

FIG. 4C illustrates content that is ranked somewhat up to non-pinned position #2;

FIG. 5 illustrates sliders that may be used by the user to manually change the line shown in FIG. 2 based on preferences;

FIG. 6A illustrates sliders that may be used by the user to manually select a type of digital media content having a theme, such movies:

FIG. 6B illustrates thumbnails of digital media content returned from a search;

FIG. 7A illustrates sliders that may be used by the user to manually select a type of digital media content having a theme, such songs;

FIG. 7B illustrates thumbnails of digital media content returned from a search; and

FIG. 8 illustrates a high-level functional block diagram of an example client device comprising a client device that communicates via network with server system.

### DETAILED DESCRIPTION

Aspects of this disclosure include a client device having a user interface, and a display displaying a graphical slider on the display that is associated with a theme of digital media content. A processor is responsive to a user moving the displayed slider between a first position and a second position, wherein the first position is correlated to a first type of digital media content and the second position is correlated to a second type of digital media content. The processor uses the position of the slider as search criteria and searches uniform resource locator (URL) content of a server that is associated with the theme of digital media content. The processor returns selected digital media content that correlates to the type of media content as a function of the slider position.

The description that follows includes systems, methods, techniques, instruction sequences, and computing machine program products illustrative of examples of the disclosure. In the following description, for the purposes of explanation, numerous specific details are set forth in order to provide an understanding of various examples of the disclosed subject matter. It will be evident, however, to those skilled in the art, that examples of the disclosed subject matter may be practiced without these specific details. In general, well-known instruction instances, protocols, structures, and techniques are not necessarily shown in detail.

Artificial neural networks are inspired from the biological neurons within the human body which activate under certain circumstances resulting in a related action performed by the body in response. Artificial neural networks consist of various layers of interconnected artificial neurons powered by activation functions which help in switching them ON/OFF. Like traditional machine algorithms, there are certain values that neural networks learn in the training phase.

Multi-layer neural networks can be used for deep learning. Inputs are multiplied with weights and fed to the activation function and in backpropagation, and they are modified to reduce the loss. In simple words, weights are machine learnt values from neural networks. They self-adjust depending on the difference between predicted outputs vs training inputs. Nonlinear activation functions are used followed by Softmax as an output.

An entry point towards complex neural networks allows input data to travel through various layers of artificial neurons. Every single node is connected to all neurons in the next layer which makes it a fully connected neural network. Input and output layers are present having multiple hidden layers, i.e. at least three or more layers in total. It has a bi-directional propagation, i.e. forward propagation and backward propagation.

Inputs are multiplied with weights and fed to the activation function and in backpropagation, they are modified to reduce the loss. In simple words, weights are machine learnt values from neural networks. They self-adjust depending on the difference between predicted outputs vs training inputs. Nonlinear activation functions are used followed by Softmax as an output layer activation function.

A trained ML model ranks content, such as a uniform resource locator (URL), and ranks-up or ranks-down the content based abstract concepts in the high-level feature embedding. A pinned-stay is where the content stays in its current place. Other content can be ranked, such as web pages, Tweets®, Facebook® posts, and social media posts. The user trains the ML model. Enterprise users may also use this ML model.

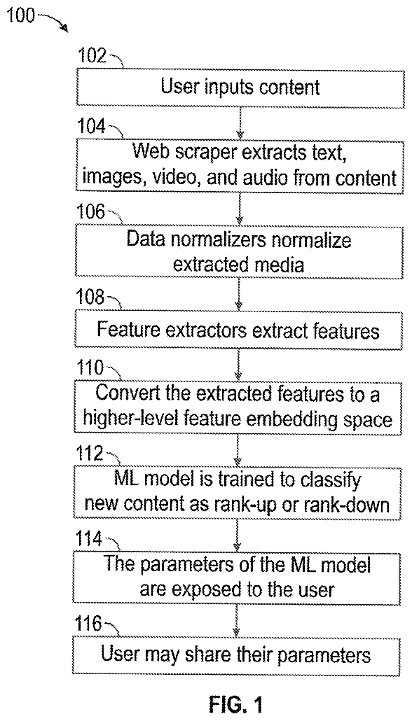

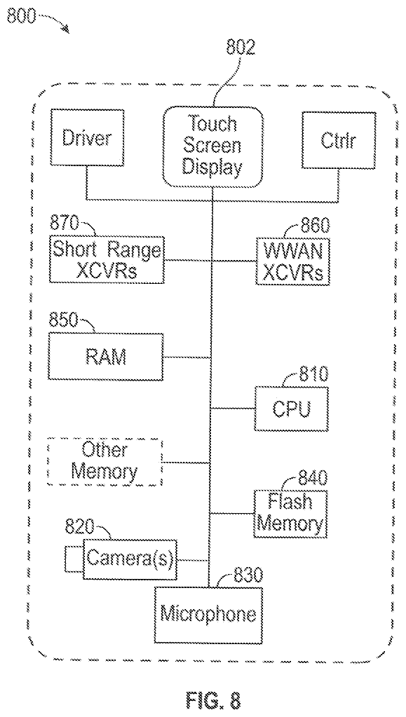

FIG. 1 is a flowchart of a method 100 of training a ML model using a processor of a client device, such as shown at 800 in FIG. 8.

At step 102, the user inputs content to the ML model. The content can be URLs, other content such as web pages, Tweets®, Facebook® posts, and social media posts.

At step 104, a web scraper extracts media from the content such as text, images, video, and audio, such as each URL.

At step 106, data normalizers normalize the extracted media, e.g. image resolution and audio volume. The data normalizers make the content more homogenous for processing, such as by comparing camera images and audio, and automatic translation of text into native languages.

At step 108, a feature extractor extracts features. The extracted features may be tokens representing words and subwords, such as described in co-pending application U.S. Ser. No. 63/341,011, the teachings of which are included herein by reference.

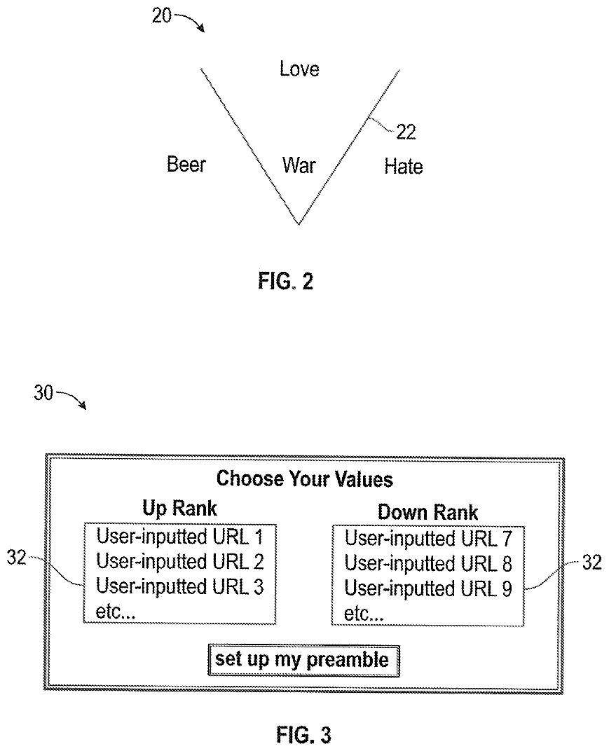

At step 110, language models and image understanding models convert the extracted features to a higher-level feature embedding space representing more abstract concepts, such as medicine, weapons, love, hate, happiness, sadness, war, protests, riots, beer, COVID, etc. Natural language understanding creates a 2-level space of the extracted features, with a 2-dimensional (2D) line separating different concepts as shown at 30 in FIG. 2. Line 22 indicates a differentiation between user acceptable content and unacceptable content, such as separating love and hate, and war and beer.

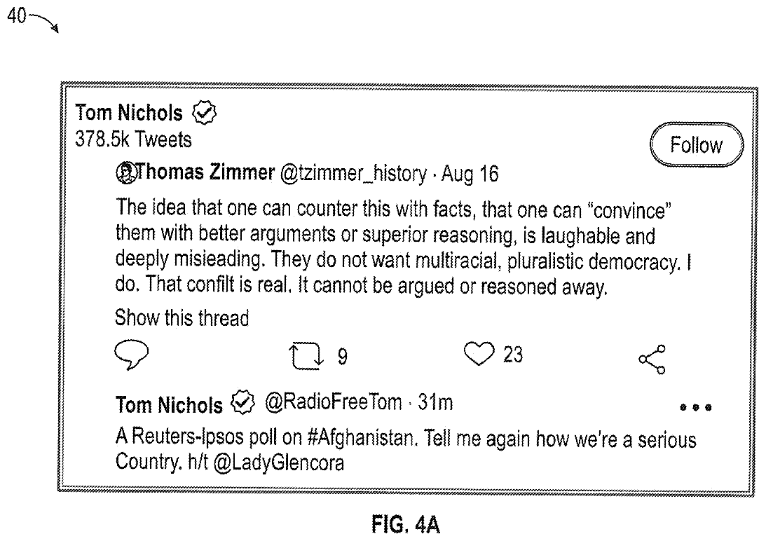

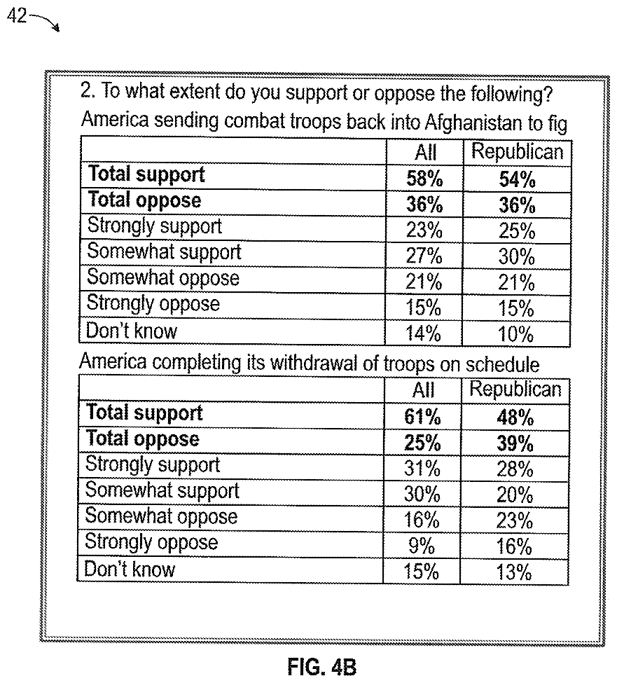

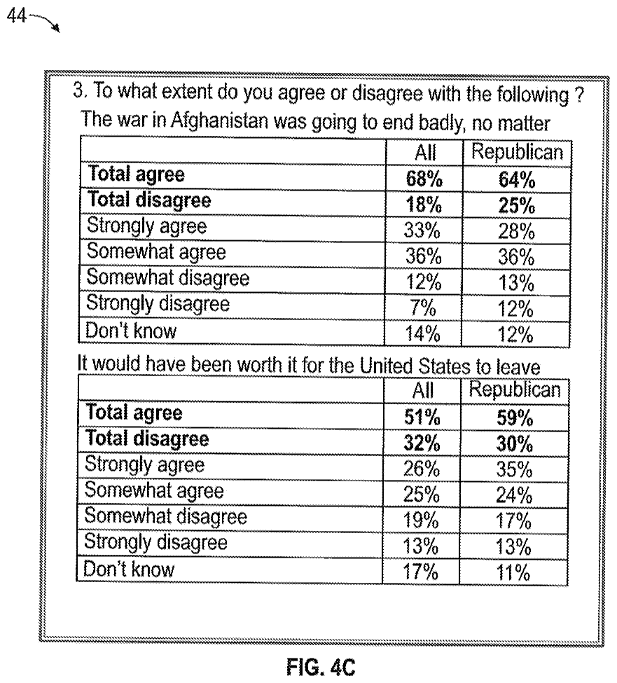

At step 112, a simplest effective model, such as a 2-level fully-connected neural network, is trained to classify the new content, such as URLs, as rank-up or rank-down based on the abstract concepts in the high-level feature embedding, as shown at 30 in FIG. 3. Multiple layers are used to classify the new content. An example of up-rank content is shown at 32, and an example of down-rank content is shown at 34. The trained ML model curates the new content and creates a preamble file. In an example, content that is pinned is shown at 40 in FIG. 4A. Content that is ranked significantly up to non-pinned position #1 is shown at 42 in FIG. 4B, and content that is ranked somewhat up to non-pinned position #2 is shown at 44 in FIG. 4C. Content that was ranked down is below the first screenful of content and requires scrolling to see it.

At step 114, the parameters of the simple learned model from step 112 are optionally exposed to the user so that the user can understand and interpret which abstract concepts were correlated most strongly with the provided rank-up and rank-down example content, such as URLs, and so that the user can manually edit some of the learned parameters if they choose.

At step 116, the user may optionally share their parameters with other users, who may import those parameter values and use them or further edit them.

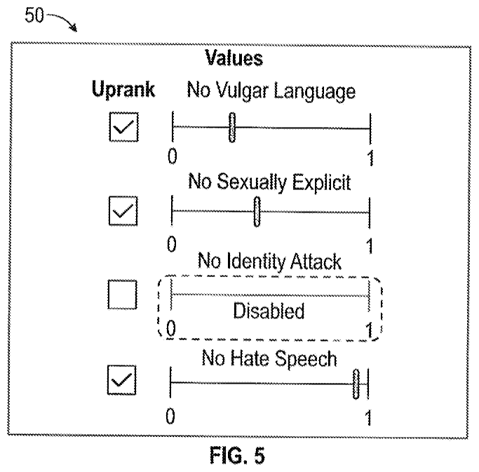

FIG. 5 illustrates sliders at 50 that may be used by the user to manually change the line 22 shown in FIG. 2 based on preferences. The sliders 50 can be user adjusted to fine-tune the line 22 between acceptable concepts and non-acceptable concepts, where the sliders 50 may establish and adjust user preferences, such as vulgar language, sexually explicit content, identity attack, and hate speech.

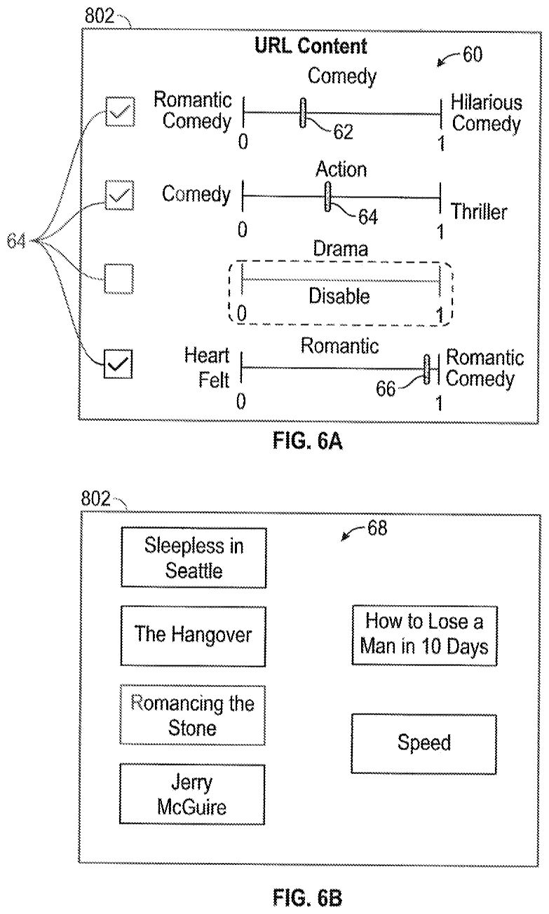

FIG. 6A illustrates sliders 60 that are displayed on display 802 of a client device 800 (FIG. 8) and configured to enable a user to manually select search criteria between related digital media preferences having a theme, such as a genre. Each of sliders 60 can be enabled by the user selecting a respective box 64 associated with the respective slider, such as tapping the respective box 64. Unchecked boxes 64 disable the respective slider. The position of sliders 60 controls the search criteria including suggested digital media content having a URL that is searched by processor 810 of a client device 800 and displayed on display 802 of the user device, such as a mobile device including a mobile phone, computer and eyewear. The processor is configured to search digital medial content stored at one or more locations, such as on a server, using clustering. Clustering is the task of grouping a set of objects in such a way that objects in the same group (called a cluster) are more similar (in some sense) to each other than to those in other groups (clusters). Clustering is a main task of exploratory data analysis, and a common technique for statistical data analysis, used in many fields, including pattern recognition, image analysis, information retrieval, bioinformatics, data compression, computer graphics and machine learning. In an example, the user may manually slide displayed slider 62 associated with a theme of comedy movie content between romantic comedies on one end, and action comedies at the opposing end of slider 60. The user may manually slide displayed slider 64 associated with action movie content between comedy on one end, and thriller at the opposing end. The user may manually slide displayed slider 66 associated with romantic movie content between heart felt on one end, and adventure at the opposing end. The selected slider position weights the user preference such that processor 810 returns displayed content that is more aligned with the user preference.

Based on the slider settings, thumbnails 68 of one or more suggested movies are displayed by processor 810 on display 802 of client device 800 as shown in FIG. 6B. In an example, when slider 62 is positioned closer to romantic comedies, the displayed suggested movies may include movies such as Sleepless in Seattle®, as shown at 68 in FIG. 6B. When slider 62 is positioned closer to hilarious comedies, the displayed suggested movies may include The Hangover®. If slider 62 is positioned in the middle of the slide, the displayed suggested movies on the user device include movies that meet both criteria, such as How to Lose a Man in 10 Days4. When slider 64 is positioned closer to action comedy, movies such as Romancing the Stone® are displayed, and when slider 64 is positioned closer to thrillers, movies such as Speed® are displayed. When slider 66 is positioned closer to heart felt romantic movies, movies such as Jerry McGuire® are displayed, and when slider 66 is positioned closer to romantic comedy, movies such as Sleepless in Seattle® are displayed. The user can select the displayed thumbnail by tapping display 802 proximate the thumbnail to begin play of the selection on display 802. In an example, this disclosure is configured to operate as a custom search engine for searching multi-media, such as for Netflix®, Hulu®, Sling® and FuboTV®.

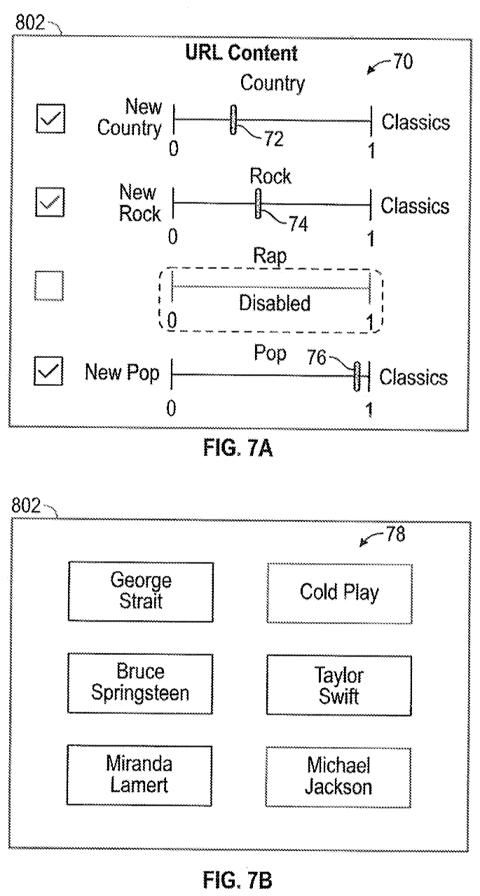

FIG. 7A illustrates sliders 70 that may be manipulated by the user to manually select search criteria between related digital media preferences of songs. In an example, the user may manually slide slider 72 associated with country song content between new country on one end, and classics at the opposing end. The user may manually slide slider 74 associated with rock song content between new rock on one end, and classics at the opposing end. The user may manually slide slider 76 associated with pop song content between new pop on one end, and classics at the opposing end. The user can select the displayed thumbnail of the suggested content to begin play of the selection.

Based on the slider settings, thumbnails 78 of one or more suggested songs are displayed by processor 810 on display 802 of client device 800 as shown in FIG. 78. In an example, when slider 72 is positioned closer to new country, the displayed suggested songs may include songs from Miranda Lambert as shown at 78 in FIG. 7B. When sider 72 is positioned closer to classics, the displayed suggested songs may include songs of George Strait. When slider 74 is positioned closer to new rock, the displayed suggested songs may include songs from Coldplay, and when slider 74 is positioned closer to classics, the displayed suggested songs may include songs from Bruce Springsteen. When slider 76 is positioned closer to new pop, the displayed songs may include songs from Taylor Swift, and when slider 76 is positioned closer to classics, the displayed songs may include songs from Michael Jackson. The user can select the displayed thumbnail of the suggested content by tapping display 802 proximate the thumbnail to begin play of the selection on display 802. In an example, this disclosure is configured to operate as a custom search engine for searching multi-media, such as for Spotify®, Pandora®, and Apple Tunes®.

Other types of digital media may be searched and displayed by processor 810, such as images. In an example, images related to animals (the theme) may be searched using a slider slidable between aggressive animals and domesticated animals.

FIG. 8 is a high-level functional block diagram of an example client device 800 including a user device that communicates via a network with server system. Display 802 is a touch screen type display, although other non-touch type displays can be used. Examples of touch screen type client devices 800 that may be used include (but are not limited to) a smart phone, a personal digital assistant (PDA), a tablet computer, a laptop computer, eyewear, or other portable device. However, the structure and operation of the touch screen type client devices is provided by way of example, and the subject technology as described herein is not intended to be limited thereto. For purposes of this discussion, FIG. 8 therefore provides a block diagram illustration of the example client device 800 having a touch screen display 802 for displaying content and receiving user input as (or as part of) the user interface. Client device 800 also includes a processor 810 such as a CPU, camera(s) 820, such as visible light camera(s), a microphone 830, memory for execution by CPU 810, such as flash memory 840 and RAM memory 850. The RAM memory 850 serves as short term storage for instructions and data being handled by the processor 810, e.g., as a working data processing memory. The flash memory 840 typically provides longer term storage.

Hence, in the example of client device 800, flash memory 840 is used to store programming or instructions for execution by processor 810. Depending on the type of device, the client device 800 stores and runs a mobile operating system through which specific applications. Examples of mobile operating systems include Google Android®, Apple iOS® (I-Phone or iPad devices), Windows Mobile®, Amazon Fire OS®, RIM BlackBerry® operating system, or the like.

As shown in FIG. 8, the client device 800 includes at least one digital transceiver (XCVR) 860, shown as WWAN XCVRs, for digital wireless communications via a wide area wireless mobile communication network. The client device 800 also includes additional digital or analog transceivers, such as short range XCVRs 870 for short-range network communication, such as via NFC, VLC, DECT, ZigBee, Bluetooth™, or WiFi. For example, short range XCVRs 870 may take the form of any available two-way wireless local area network (WLAN) transceiver of a type that is compatible with one or more standard protocols of communication implemented in wireless local area networks, such as one of the Wi-Fi standards under IEEE 802.11, 4G LTE and 5G.

To generate location coordinates for positioning of the client device 800, the client device 800 can include a global positioning system (GPS) receiver (not shown). Alternatively, or additionally, the client device 800 can utilize either or both the short range XCVRs 870 and WWAN XCVRs 860 for generating location coordinates for positioning. For example, cellular network, WiFi, or Bluetooth™ based positioning systems can generate very accurate location coordinates, particularly when used in combination. Such location coordinates can be transmitted to the eyewear device over one or more network connections via XCVRs 870.

The transceivers 860, 870 (network communication interface) conforms to one or more of the various digital wireless communication standards utilized by modern mobile networks. Examples of WWAN transceivers 860 include (but are not limited to) transceivers configured to operate in accordance with Code Division Multiple Access (CDMA) and 3rd Generation Partnership Project (3GPP) network technologies including, for example and without limitation, 3GPP type 2 (or 3GPP2) and LTE, at times referred to as “4G”, and 5G. For example, the transceivers 860, 870 provide two-way wireless communication of information including digitized audio signals, still image and video signals, web page information for display as well as web related inputs, and various types of mobile message communications to/from the client device 800 for user identification strategies.

Several of these types of communications through the transceivers 860, 870 and a network, as discussed previously, relate to protocols and procedures in support of communications with the physically remote server system (not shown) for obtaining and storing friend device capabilities. Such communications, for example, may transport packet data via the short range XCVRs 870 over the wireless connections of network to and from the server system. Such communications, for example, may also transport data utilizing IP packet data transport via the WWAN XCVRs 860 over the network (e.g., Internet). Both WWAN XCVRs 860 and short range XCVRs 870 connect through radio frequency (RF) send-and-receive amplifiers (not shown) to an associated antenna (not shown).

Microprocessor 810, shown as a CPU, sometimes referred to herein as the host controller. A processor is a circuit having elements structured and arranged to perform one or more processing functions, typically various data processing functions. Although discrete logic components could be used, the examples utilize components forming a programmable CPU. A microprocessor for example includes one or more integrated circuit (IC) chips incorporating the electronic elements to perform the functions of the CPU. The processor 810, for example, may be based on any known or available microprocessor architecture, such as a Reduced Instruction Set Computing (RISC) using an ARM architecture, as commonly used today in client devices and other portable electronic devices. Other processor circuitry may be used to form the CPU 810 or processor hardware in smartphone, laptop computer, and tablet.

The microprocessor 810 serves as a programmable host controller for the client device 800 by configuring the device to perform various operations, for example, in accordance with instructions or programming executable by processor 800. For example, such operations may include various general operations of the client device 800. Although a processor may be configured by use of hardwired logic, typical processors in client devices are general processing circuits configured by execution of programming.

The terms and expressions used herein are understood to have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises.” “comprising,” “includes,” “including,” or any other variation thereof, are intended to cover a non-exclusive inclusion, such that a process, method, article, or apparatus that comprises or includes a list of elements or steps does not include only those elements or steps but may include other elements or steps not expressly listed or inherent to such process, method, article, or apparatus. An element preceded by “a” or “an” does not, without further constraints, preclude the existence of additional identical elements in the process, method, article, or apparatus that comprises the element.

In addition, in the foregoing Detailed Description, it can be seen that various features are grouped together in various examples for the purpose of streamlining the disclosure. This method of disclosure is not to be interpreted as reflecting an intention that the claimed examples require more features than are expressly recited in each claim. Rather, as the following claims reflect, the subject matter to be protected lies in less than all features ofany single disclosed example. Thus, the following claims are hereby incorporated into the Detailed Description, with each claim standing on its own as a separately claimed subject matter.

The examples illustrated herein are described in sufficient detail to enable those skilled in the art to practice the teachings disclosed. Other examples may be used and derived therefrom, such that structural and logical substitutions and changes may be made without departing from the scope of this disclosure. The Detailed Description, therefore, is not to be taken in a limiting sense, and the scope of various examples is defined only by the appended claims, along with the full range of equivalents to which such claims are entitled.

Additional objects, advantages and novel features of the examples will be set forth in part in the description which follows, and in part will become apparent to those skilled in the art upon examination of the following and the accompanying drawings or may be learned by production or operation of the examples. The objects and advantages of the present subject matter may be realized and attained by means of the methodologies, instrumentalities and combinations particularly pointed out in the appended claims.

1. A client device, comprising:
a user interface configured to allow a user to enter user input;
a memory;
a display;
a processor coupled to the memory; and
instructions stored in the memory that, when executed by the processor, configure the processor to:
display a graphical slider on the display that is associated with a theme of digital media content;
receive the user input via the user interface to responsively move the displayed slider between a first position and a second position, wherein the first position is correlated to a first type of the digital media content and the second position is correlated to a second type of the digital media content; and
search uniform resource locator (URL) content associated with the theme of the digital media content and return selected digital media content that correlates to the type of digital media content as a function of the slider position.

2. The client device of claim 1, wherein the URL content is stored on a server.

3. The client device of claim 1, wherein the returned selected digital media content comprises a thumbnail indicative of the returned selected media content.

4. The client device of claim 2, wherein the digital media content comprises movies.

5. The client device of claim 2, wherein the digital media content comprises songs.

6. The client device of claim 1, wherein the theme comprises a genre.

7. The client device of claim 6, wherein the genre is selected from the group comprising comedy, action and romantic movies.

8. The client device of claim 1, wherein the graphical slider provides a weight to the searched URL content.

9. The client device of claim 8, wherein the returned selected digital media content is more similar to the first type of digital media content than the second type of digital media content when the graphical slider is closer to the first position, and is more similar to second type of digital media content than the first type of digital media content when the graphical slider is closer to the second position.

10. A method of operating a client device having a user interface configured to allow a user to enter user input, a memory, a display, a processor coupled to the memory, the method comprising the processor:
displaying a graphical slider on the display that is associated with a theme of digital media content;
receiving the user input via the user interface to responsively move the displayed slider between a first position and a second position, wherein the first position is correlated to a first type of the digital media content and the second position is correlated to a second type of the digital media content; and
searching uniform resource locator (URL) content associated with the theme of the digital media content and returning selected digital media content that correlates to the type of digital media content as a function of the slider position.

11. The method of claim 10, wherein the URL is stored on a server.

12. The method of claim 10, wherein the returned selected digital media content comprises a thumbnail indicative of the returned selected digital media content.

13. The method of claim 11, wherein the digital media content comprises movies.

14. The method of claim 11, wherein the digital media content comprises songs.

15. The method of claim 10, wherein the theme comprises a genre.

16. The method of claim 15, wherein the genre is selected from the group comprising comedy, action and romantic movies.

17. The method of claim 10, wherein the graphical slider provides a weight to the searched URL content.

18. The method of claim 17, wherein wherein the returned selected media is more similar to the first type of media content than the second type of media when the graphical slider is closer to the first position, and is more similar to second type of media content than the first type of media when the graphical slider is closer to the second position.

19. A non-transitory computer-readable medium storing program code which, when executed, is operative to cause an electronic processor of a client device to perform the steps of:
displaying a graphical slider on the display that is associated with a theme of digital media content;
receiving the user input via the user interface to responsively move the displayed slider between a first position and a second position, wherein the first position is correlated to a first type of the digital media content and the second position is correlated to a second type of the digital media content; and
searching uniform resource locator (URL) content associated with the theme of the digital media content and returning selected digital media content that correlates to the type of digital media content as a function of the slider position.

20. The non-transitory computer-readable medium of claim 19, wherein the code is operative such that the returned selected digital media content is more similar to the first type of digital media content than the second type of digital media content when the graphical slider is closer to the first position, and is mom similar to second type of digital media content than the first type of digital media content when the graphical slider is closer to the second position
